(19) United States
(12) Patent Application Publication
(10) Pub. No.: US 2008/0013330 A1
(43) Pub. Date: Jan. 17, 2008

(54) Rotatable vehicular lamp assembly having a limiting unit

(76) Inventor: Chian-Yin Tseng, Tainan City (TW)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 11/827,004

(22) Filed: Jul. 10, 2007

(30) Foreign Application Priority Data
Jul. 11, 2006 (TW) 095125235

(51) Int. Cl. B60Q 1/08

(52) U.S. Cl. 362/465

(57) ABSTRACT

A rotatable vehicular lamp assembly includes a main frame, and a lighting unit including a lamp seat holder connected pivotally to the main frame, and a lamp seat connected to and rotating synchronously with the lamp seat holder. A drive unit is mounted on the main frame to rotate the lamp seat holder relative to the main frame. A limiting unit is provided to limit a rotating angle of the lamp seat holder to a preset angle, and includes at least one light sensor on the main frame, and at least one light obstructing piece connected to and rotating synchronously with the lamp seat holder. The light sensor sends a signal to the drive unit to stop rotation of the lamp seat holder when detecting an arrival of the light obstructing piece.

### CROSS-REFERENCE TO RELATED APPLICATION

This application claims priority of Taiwanese Application No. 095125235, filed on Jul. 11, 2006.

### BACKGROUND OF THE INVENTION

1. Field of the Invention

This invention relates to a rotatable vehicular lamp assembly, more particularly to a rotatable vehicular lamp assembly that has a lamp seat holder which rotates synchronously with the turning of a vehicle.

2. Description of the Related Art

Conventional vehicular lamps are fixed to front sides of a vehicle. When the vehicle turns along a curve in the road, since the vehicular lamps cannot concurrently turn, portions of the road may not be illuminated by the vehicular lamps, so that the conventional vehicular lamps cannot provide a driver of the vehicle a clear and bright situation of the roadway.

In order to resolve the aforementioned drawback, many manufacturers have performed research and development on vehicular lamps. Currently available in the market is a vehicular lamp that can be controlled so as to rotate. The vehicular lamp includes a fixed base seat, a lighting unit connected pivotally to a front side of the fixed base seat so as to be movable leftward and rightward, and a drive unit mounted on the fixed base seat and driving the lighting unit to rotate. In use, through a computer control system of the vehicle, the drive unit is activated so as to rotate the lighting unit synchronously with the steering wheel or the vehicle wheels and by an amount that is a function of the rotating angle of the steering wheel or vehicle wheels, so that the driver can clearly see in advance the condition of the road when turning a corner. Hence, accidents can be prevented, and safety during driving is enhanced.

However, the aforementioned vehicular lamp is not provided with any limiting structure to control the rotating angle of the lighting unit, so that when the drive unit activates the lighting unit to rotate, the rotating angle of the lighting unit can be excessive, and even extend beyond the maximum preset angle of the system. This may result in mis-calibration of the system such that, ultimately, the computer control system transmits wrong signals that result in inaccurate angle of rotation of the lighting unit.

### SUMMARY OF THE INVENTION

Therefore, the object of the present invention is to provide a rotatable vehicular lamp assembly that has a limiting unit to limit and to control accurately a rotating angle of a lamp seat holder thereof.

According to this invention, a rotatable vehicular lamp assembly comprises a main frame, a lighting unit, a drive unit, and a limiting unit. The lighting unit includes a lamp seat holder connected pivotally to the main frame for rotation relative to the main frame, and a lamp seat connected to and rotating synchronously with the lamp seat holder. The drive unit is mounted on the main frame to rotate the lamp seat holder relative to the main frame. The limiting unit is provided to limit a rotating angle of the lamp seat holder to a preset angle, and includes at least one light sensor mounted on the main frame, and at least one light obstructing piece connected to and rotating synchronously with the lamp seat holder. The light sensor and the light obstructing piece move to each other when the rotating angle of the lamp seat holder is as large as the preset angle. The light sensor sends a signal to the drive unit to stop rotation of the lamp seat holder when detecting an arrival of the light obstructing piece.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a rotatable vehicular lamp assembly according to the preferred embodiment of the present invention;

FIG. 2 is a schematic side view of the preferred embodiment;

FIG. 3 is a partially sectioned top view of the preferred embodiment; and

FIG. 4 is a view similar to FIG. 3, but illustrating how a rotating angle of a lighting unit of the preferred embodiment is limited by a limiting unit.

### DETAILED DESCRIPTION OF THE PREFERRED EMBODIMENT

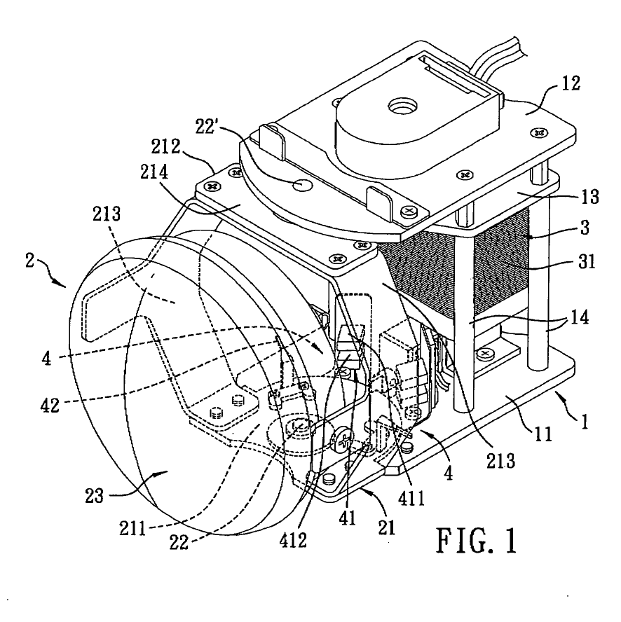

Referring to FIGS. 1 to 4, there is shown a rotatable vehicular lamp assembly according to the preferred embodiment of the present invention that may be installed on a left or a right side of a vehicle (not shown). The assembly comprises a main frame 1, a lighting unit 2, a drive unit 3, and a limiting unit 4.

The main frame 1 has a horizontal bottom main plate 11, a horizontal top main plate 12 spaced apart from the bottom main plate 11, and a horizontal partition plate 13 connected between rear sides of the top and bottom main plates 12, 11 through a plurality of support rods 14.

The lighting unit 2 includes a lamp seat holder 21 disposed between the front sides of the top and bottom main plates 12, 11, two pivot pins 22′, 22 connecting pivotally the lamp seat holder 21 to the top and bottom main plates 12, 11 so that the lamp seat holder 21 is rotatable leftward and rightward about an axis (X), which extends perpendicularly through the top and bottom main plates 12, 11, and a lamp seat 23 connected to and rotating synchronously with the lamp seat holder 21. The lamp seat holder 21 has a bottom holder plate 211 connected pivotally to and disposed above the front side of the bottom main plate 11 through the pivot pin 22, a top holder plate 212 disposed below the front side of the top main plate 12, and two curved side plates 213 connected between the bottom and top holder plates 211, 212. The top holder plate 212 has a front plate portion 214 connected pivotally to the top main plate 12 through the pivot pin 22′, and a sector-shaped gear-toothed plate portion 215 extending rearwardly from the front plate portion 214 and having a periphery formed with a plurality of engaging teeth 217. The front plate portion 214 has left and right engaging edges 216 disposed respectively at two opposite front ends of the gear-toothed plate portion 215.

The drive unit 3 includes a motor 31 mounted between the bottom main plate 11 and the partition plate 13 to rotate the lamp seat holder 21 relative to the main frame 1, a motor output gear 32 disposed between the partition plate 13 and the top main plate 12 and driven by the motor 31, and a driven gear 33 disposed between the partition plate 13 and the top main plate 12 and meshed between the motor output gear 32 and the engaging teeth 217 of the gear-toothed plate portion 215 of the top holder plate 212. The motor 31 is a step motor in this embodiment. The motor output gear 32 is sleeved on a drive shaft of the motor 31.

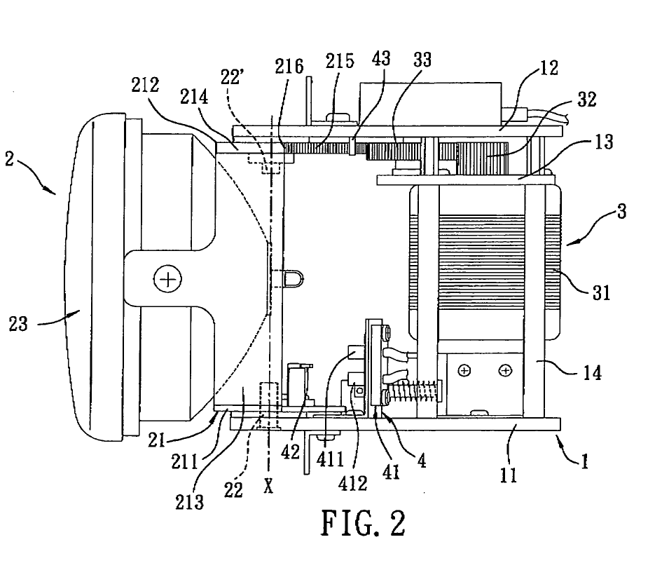

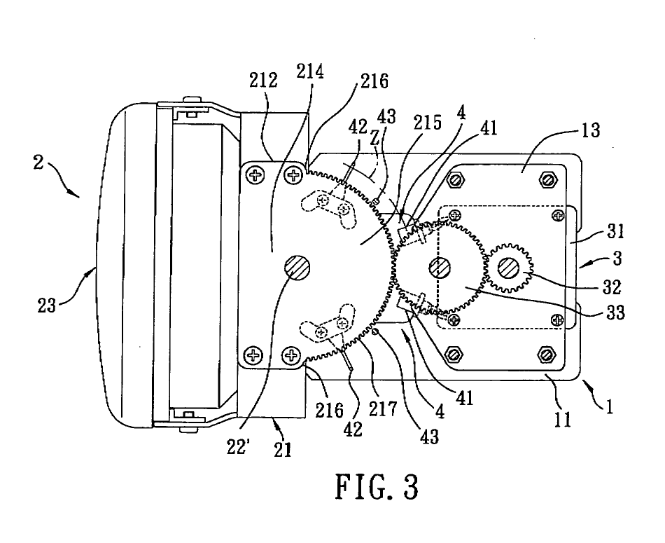

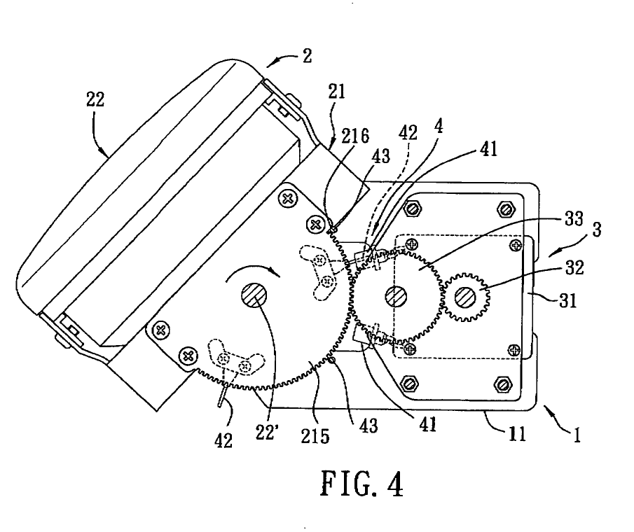

The limiting unit 4 is used for limiting the rotating angle of the lighting unit 2, i.e., the lamp seat holder 21 and the lamp seat 23, so that the rotating angle does not exceed a preset angle. As shown in FIGS. 3 and 4, the limiting unit 4 includes angularly spaced-apart left and right light sensors 41 fixed to the bottom main plate 11, angularly spaced-apart left and right light obstructing pieces 42 fixed to the bottom holder plate 211 (see FIGS. 1 and 2) so as to rotate synchronously with the lamp seat holder 21, and angularly spaced-apart left and right limiting members 43 disposed on a bottom face of the top main plate 12. For the sake of brevity, the lighting unit 2 will be described hereinafter with reference to one of the left and right light sensors 41, one of the left and right light obstructing pieces 42, and one of the left and right limiting members 43.

The light sensor 41 has a light emitter 411 and a light receiver 412 spaced apart from each other in a top-to-bottom manner. The light emitter 411 emits continuously a light signal to the light receiver 412. The light obstructing piece 42 is movable along a curved path (Z) about the axis (X). The curved path (Z) extends through the light sensor 41. The light obstructing piece 42 is spaced apart angularly from the light sensor 41 when the rotating angle of the lamp seat holder 21 or the lamp seat 23 has not reached the preset angle. When the preset angle is reached, the light obstructing piece 42 moves to the light sensor 41. The limiting member 43 is proximate to the curved path (Z) and engageable with one of the engaging edges 216 of the top holder plate 212 when the rotating angle of the lamp seat holder 21 reaches the preset angle.

Under a normal use state, a light source in the lamp seat 23 emits light forwardly. With reference to FIGS. 1 and 4, when the steering wheel or the vehicle wheel is turned rightward, the motor 31 is activated so as to rotate the motor output gear 32, the driven gear 33 which is meshed with the motor output gear 32, and the gear-toothed plate portion 215 which is meshed with the driven gear 33, so that the lamp seat holder 21 and the lamp seat 23 turn synchronously with the steering wheel or the vehicle wheel. At this time, the light obstructing piece 42 moves along with the lamp seat holder 21. When the rotating angle of the lamp seat holder 21 reaches the preset angle, the light obstructing piece 42 extends between the light emitter 411 and the light receiver 412 of the light sensor 41 so as to block the light signal emitting from the light emitter 411 to the light receiver 412. As a result, the light sensor 41 instantaneously sends a signal to the motor 31 to stop rotation of the lamp seat holder 21. The engaging edge 216 abuts against the limiting member 43 at this time so that the lamp seat holder 21 and the lamp seat 23 are additionally prevented from rotating further.

It should be noted that the position of the limiting unit 4 may also be altered. For example, the light sensor 41 may be fixed to the top main plate 12 of the main frame 11, in which case the light obstructing piece 42 is fixed to the top holder plate 212 of the lamp seat holder 21, and the limiting member 43 is fixed to the bottom main plate 11. In another example, the light sensor 41 may be fixed to the lamp seat holder 21, in which case the light obstructing piece 42 is fixed to the main frame 1. The aforementioned designs similarly have the effect of limiting the rotation of the lamp seat holder 21 within a preset angle. Hence, the design of the present invention is not limited to the disclosed embodiment.

From the aforementioned description, it is apparent that the rotatable vehicular lamp assembly of the present invention is provided with the limiting unit 4 so that the rotating angle of the lighting unit 2 will not exceed the preset angle of a computer control system of the vehicle. As such, excessive rotation of the lighting unit 2 is prevented.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A rotatable vehicular lamp assembly, comprising:
a main frame;
a lighting unit including a lamp seat holder connected pivotally to said main frame for rotation relative to said main frame, and a lamp seat connected to and rotating synchronously with said lamp seat holder;
a drive unit mounted on said main frame to rotate said lamp seat holder relative to said main frame; and
a limiting unit to limit a rotating angle of said lamp seat holder to a preset angle, said limiting unit including at least one light sensor mounted on said main frame, and at least one light obstructing piece connected to and rotating synchronously with said lamp seat holder, said light sensor and said light obstructing piece moving to each other when said rotating angle of said lamp seat holder is as large as said preset angle, said light sensor sending a signal to said drive unit to stop rotation of said lamp seat holder when detecting an arrival of said light obstructing piece.

2. The rotatable vehicular lamp assembly of claim 1, wherein said lamp seat holder is rotatable about an axis, said light obstructing piece being movable along a curved path about said axis, said curved path extending through said light sensor, said light obstructing piece and said light sensor being spaced apart angularly from each other when said rotating angle of said lamp seat holder is smaller than said preset angle.

3. The rotatable vehicular lamp assembly of claim 2, wherein said limiting unit includes a pair of said light sensors that are spaced apart angularly, and a pair of said light obstructing pieces that are spaced apart angularly.

4. The rotatable vehicular lamp assembly of claim 2, wherein said light sensor has a light emitter and a light receiver that are spaced apart from each other, said light obstructing piece extending between said light emitter and said light receiver so as to block a light signal emitting from said light emitter to said light receiver.

5. The rotatable vehicular lamp assembly of claim 2, wherein said limiting unit further includes a limiting member disposed on said main frame to engage said lamp seat holder when said rotating angle of said lamp seat holder is as large as said preset angle.

6. The rotatable vehicular lamp assembly of claim 5, wherein said main frame has top and bottom main plates, said lamp seat holder being connected pivotally to said top and bottom main plates, said axis of said lamp seat holder extending perpendicularly through said top and bottom main plates.

7. The rotatable vehicular lamp assembly of claim 6, wherein said lamp seat holder has a bottom holder plate connected pivotally to said bottom main plate, and a top holder plate connected pivotally to said top main plate, said light obstructing piece being mounted on said bottom holder plate, said light sensor being mounted on said bottom main plate, said limiting member being fixed to said top main plate, said top holder plate having an engaging edge to engage said limiting member.

8. The rotatable vehicular lamp assembly of claim 7, wherein said top holder plate of said lamp seat holder has a sector-shaped gear-toothed plate portion, said drive unit including a motor installed in said main frame, a motor output gear driven by said motor, and a driven gear mounted on said top main plate and meshed between said motor output gear and said gear-toothed plate portion.

9. The rotatable vehicular lamp assembly of claim 8, wherein said motor is a step motor.
